(19) United States
(12) Patent Application Publication
(10) Pub. No.: US 2026/0342838 A1
(43) Pub. Date: Oct. 29, 2026

(54) PRIORITY-BASED DYNAMIC ADJUSTMENT OF OBSERVABILITY CONFIGURATIONS VIA AUTONOMOUS PENTESTING

(71) Applicant: Horizon 3 AI, Inc., Dover, DE (US)

(72) Inventors: Anthony Pillitiere, Wesley Chapel, FL (US); Eric Alford, Wesley Chapel, FL (US); Brian Marr, Nesbit, MS (US); Snehal Antani, San Francisco, CA (US)

(21) Appl. No.: 19/192,553

(22) Filed: Apr. 29, 2025

(51) Int. Cl. H04L 9/40; H04L 41/08

(52) U.S. Cl. CPC H04L 63/1433; H04L 41/0883; H04L 63/20

(57) ABSTRACT

An autonomous pentesting agent may dynamically adjust an observability configuration for a network based on autonomous pentesting operations. The agent may execute an autonomous pentest of a network including performing one or more sequences of autonomous pentesting operations along one or more attack paths and at one or more network assets of multiple network assets of the network. The agent may classify the one or more network assets into priority levels based on a context of each network asset of the one or more network assets within the network and on an attack path of the one or more attack paths of the autonomous pentest associated with each network asset. The agent may perform one or more adjustments to an observability configuration in accordance with classifying the one or more network assets into the priority levels.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support priority-based dynamic adjustment of observability configurations via autonomous pentesting. For example, an autonomous pentesting agent may use contextual information of an attack path executed during an autonomous pentest, information about network assets in the attack path, and telemetry capabilities of the network assets in the attack path to modify one or more observability configurations of the network. Specifically, the autonomous pentesting agent may modify the one or more observability configurations to enable detection of the techniques, tactics, and procedures (TTPs) leveraged within that attack path and/or increase an amount of information available for the network assets within the attack path (e.g., for an observer of logs of the network, such as a Security Operations Center (SOC) analyst, a human, or another anomaly detection system).

In some aspects, the techniques described herein relate to a method for priority-based dynamic adjustment of observability configurations via autonomous pentesting, including: executing an autonomous pentest of a network, the autonomous pentest including performing one or more sequences of autonomous pentesting operations along one or more attack paths and at one or more network assets of a plurality of network assets of the network; classifying the one or more network assets into priority levels based at least in part on a context of each network asset of the one or more network assets within the network and on an attack path of the one or more attack paths of the autonomous pentest associated with each network asset; and performing one or more adjustments to an observability configuration in accordance with classifying the one or more network assets into the priority levels.

In some aspects, the techniques described herein relate to an apparatus for priority-based dynamic adjustment of observability configurations via autonomous pentesting, including: one or more memories storing processor-executable code; and one or more processors coupled with the one or more memories and individually or collectively operable to execute the code to cause the apparatus to: execute an autonomous pentest of a network, the autonomous pentest including performing one or more sequences of autonomous pentesting operations along one or more attack paths and at one or more network assets of a plurality of network assets of the network; classify the one or more network assets into priority levels based at least in part on a context of each network asset of the one or more network assets within the network and on an attack path of the one or more attack paths of the autonomous pentest associated with each network asset; and perform one or more adjustments to an observability configuration in accordance with classifying the one or more network assets into the priority levels.

In some aspects, the techniques described herein relate to a non-transitory computer-readable medium storing code for priority-based dynamic adjustment of observability configurations via autonomous pentesting, the code including instructions executable by one or more processors to: execute an autonomous pentest of a network, the autonomous pentest including performing one or more sequences of autonomous pentesting operations along one or more attack paths and at one or more network assets of a plurality of network assets of the network; classify the one or more network assets into priority levels based at least in part on a context of each network asset of the one or more network assets within the network and on an attack path of the one or more attack paths of the autonomous pentest associated with each network asset; and perform one or more adjustments to an observability configuration in accordance with classifying the one or more network assets into the priority levels.

### BRIEF DESCRIPTION OF THE DRAWINGS

FIG. 1 shows an example of a computing environment that supports priority-based dynamic adjustment of observability configurations via autonomous pentesting in accordance with aspects of the present disclosure.

FIG. 2 shows an example of an autonomous pentest map that supports priority-based dynamic adjustment of observability configurations via autonomous pentesting in accordance with aspects of the present disclosure.

FIG. 3 shows an example of a computing environment that supports priority-based dynamic adjustment of observability configurations via autonomous pentesting in accordance with aspects of the present disclosure.

FIGS. 4 and 5 show examples of flow diagrams that support priority-based dynamic adjustment of observability configurations via autonomous pentesting in accordance with aspects of the present disclosure.

FIG. 6 shows a diagram of a system including a device that supports priority-based dynamic adjustment of observability configurations via autonomous pentesting in accordance with aspects of the present disclosure.

FIG. 7 shows a flowchart illustrating methods that support priority-based dynamic adjustment of observability configurations via autonomous pentesting in accordance with aspects of the present disclosure.

### DETAILED DESCRIPTION

A network may store records of events related to activity in the network. For example, the network may record and store documentation of events occurring across the network in files. As used herein, recording and storing documentation of events may be referred to as “logging,” and the files that store such information may be referred to as “logs.” That is, the network (or a third-party service associated with the network) may log events in one or more logs to track activity across the network. In some examples, a network may use a Security Information and Event Management (SIEM) system to collect log data from different sources within the network. For example, the SIEM system may collect and store documentation of events in one or more logs related to different activities across the network, including system information, application information, security information, network traffic information, or the like. The logs may be used to identify and understand trends as well as detect abnormal activity. For example, logs may be used to identify unauthorized access, detect data breaches, comply with regulatory standards, troubleshoot, and perform attack detection and analysis. The SIEM system may calibrate logging configurations to detect abnormalities in network activity quickly and accurately, record relevant information, and prevent inefficient allocation of resources.

An autonomous pentesting agent may calibrate logging configurations according to autonomous pentesting data. For example, by performing one or more autonomous pentests of the network, the autonomous pentesting agent may identify network assets vulnerable to attack and determine impacts of compromise events associated with potential attacks on network assets. In other words, the autonomous pentesting agent may identify which network assets are relatively more vulnerable than others and which network assets may be compromised to achieve compromise events having relatively high severity levels (e.g., full domain compromise, as opposed to a host compromise). Using this autonomous pentesting data, the autonomous pentesting agent may classify network assets into risk priority levels (e.g., critical, high, medium, low, etc.) and dynamically adjust logging configurations. For example, the autonomous pentesting agent may increase logging associated with a network asset identified in multiple attack paths and used to achieve a domain compromise event. Alternatively, the autonomous pentesting agent may decrease logging associated with a network asset identified via a network scan but not used in the attack paths of the autonomous pentest. In other words, the autonomous pentesting agent may reallocate logging resources based on autonomous pentesting data.

Additionally, the autonomous pentesting agent may compare logs of the autonomous pentest to logs of the network stored in a SIEM system. Based on the comparison, the autonomous pentesting agent may increase logging associated with event types indicative of an attack. That is, the autonomous pentesting agent may compare logs of the autonomous pentest to logs of the network to identify whether the network recorded events associated with autonomous pentesting operations. If not, the autonomous pentesting agent may adjust the logging configurations such that the SIEM system records events that may indicate attacks or provide a user additional information that may be used to identify anomalous behavior. Accordingly, the autonomous pentesting agent may improve the ability of the SIEM system to detect attacks on the network via the logs by adjusting logging configurations in accordance with autonomous pentesting data.

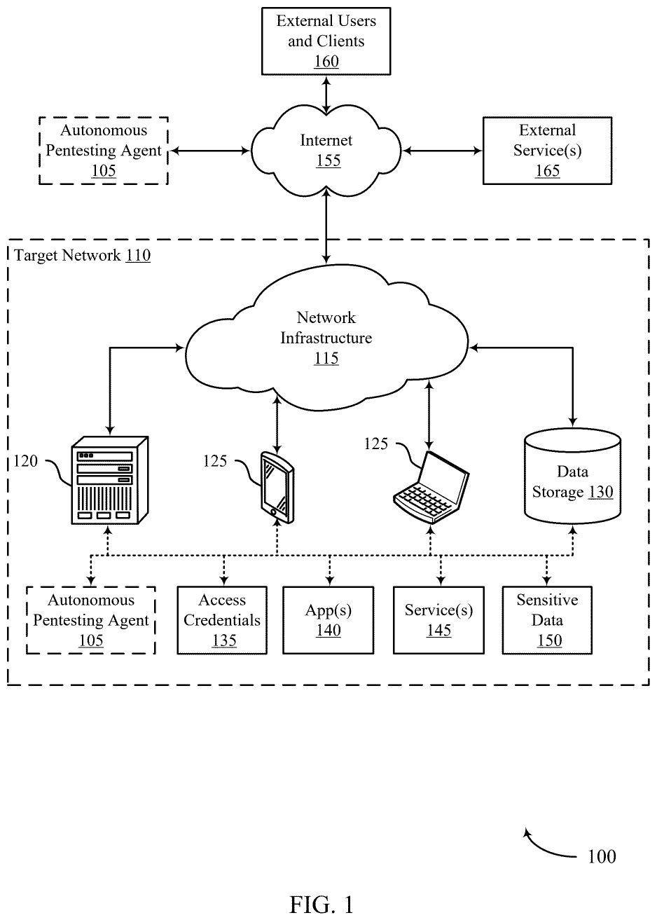

FIG. 1 illustrates an example of a computing environment 100 that supports in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and service(s) 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and service(s) 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (access credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

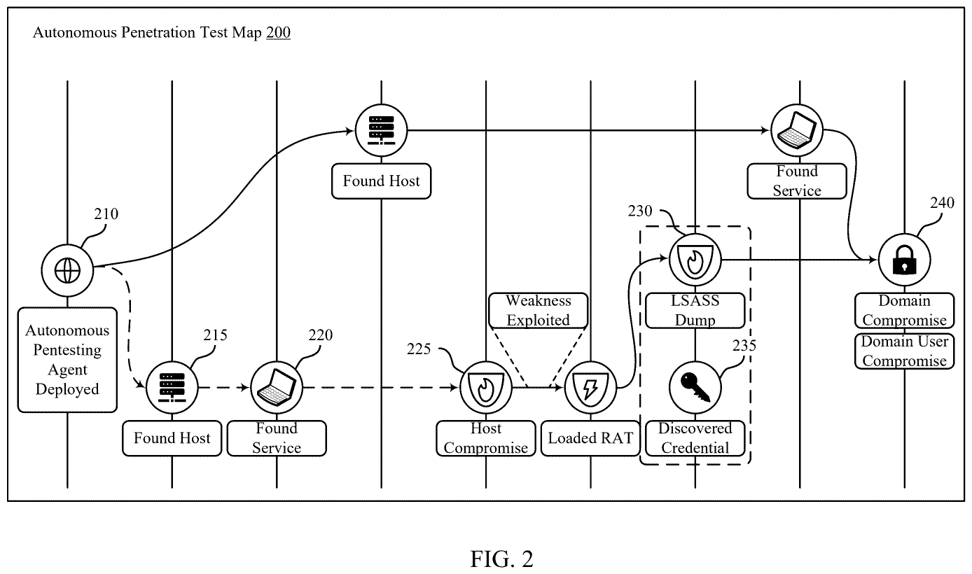

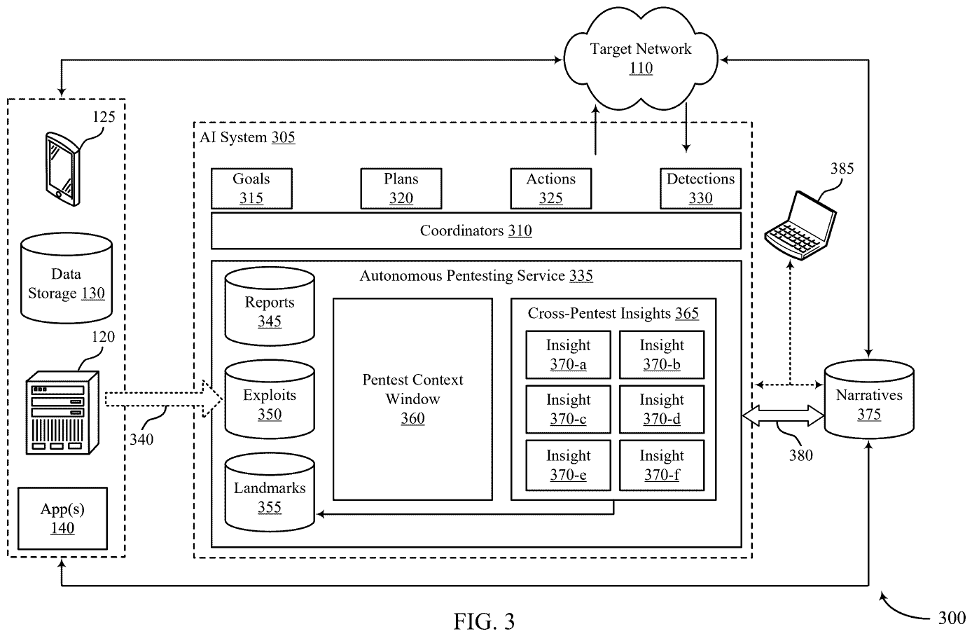

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more artificial intelligence (AI) models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, that enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein the autonomous pentesting agent 105 may execute an autonomous pentest of the target network 110 including performing one or more sequences of autonomous pentesting operations along one or more attack paths and at one or more network assets (e.g., the server 120, the computing devices 125, the data storage 130, the access credentials 135, the app(s) 140, the service(s) 145, or other types of network assets not shown). The autonomous pentesting agent 105 may classify the network assets into risk priority levels based on a context of each network asset within the target network 110 (e.g., how important the network asset is, such as whether the network asset has administrator privileges, access to other network assets, etc.) and on an attack path of the autonomous pentest associated with each network asset (e.g., severity of compromise event(s) in the attack path, such as high severity for domain compromise, medium severity for host compromise, etc.). The autonomous pentesting agent 105 may perform adjustments to an observability configuration associated with the target network 110 based on classifying the network assets.

By adjusting the observability configuration based on risk priority levels of the network assets, the autonomous pentesting agent 105 may improve use of logging resources. For example, the autonomous pentesting agent 105 may reallocate logging resources to higher priority network assets from lower priority network assets, thereby ensuring that logging resources correspond to the risk priority levels. In other words, the autonomous pentesting agent 105 may quickly and dynamically amplify logging of higher priority network assets (e.g., a particular system or set of systems identified as being exploitable during or in an attack path of an autonomous pentest) and/or reduce logging of lower priority network assets (e.g., a remaining system or set of systems, such as those not within the attack path of the autonomous pentest). Additionally, because the risk priority levels are based on autonomous pentesting data (e.g., context of network assets within the target network 110 and attack paths), the autonomous pentesting agent 105 may reallocate the logging resources based on potential attacks to the network. In other words, by adjusting the observability configuration based on autonomous pentesting data (e.g., proven attack paths and exploits found during the autonomous pentest), the autonomous pentesting agent 105 may improve a fidelity of signals within exploitable attack path(s), thus improving a likelihood of identification of anomalous behavior and threat actor movements using logs of the network. Aligning the observability configuration with possible attacks identified via autonomous pentesting may improve detection ability and speed by a SIEM system associated with the network and, accordingly, improve security of the target network 110. In other words, the SIEM system (or a user associated with the SIEM system) may identify possible attacks or anomalous activity with improved accuracy at the higher priority network assets based on logging for those network assets being amplified.

FIG. 2 shows an example of an autonomous pentest map 200 that supports in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support dynamic updates to an observability configuration associated with a network based on autonomous pentesting data. For example, the autonomous pentesting service may classify network assets into risk priority levels based on a context of each network asset within the network and on an attack path of the autonomous pentest associated with each network asset. As an example, the autonomous pentesting service may use the attack path in the autonomous pentest map 200 to determine the severity of a compromise event that a network asset, if compromised, may lead to. In other words, the autonomous pentesting service may use the information in the autonomous pentest map 200 to classify network assets into risk priority levels and perform adjustments to the observability configuration in accordance with the risk priority levels. In one example, the autonomous pentesting service may increase logging associated with the credential (e.g., track failed login attempts, failed multi-factor authentication (MFA) attempts, etc.) of the credential identification 235 event, as the credential was used to achieve domain compromise.

FIG. 3 shows an example of a computing environment 300 that supports priority-based dynamic adjustment of observability configurations via autonomous pentesting in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service may utilize the AI system 305 to analyze vulnerabilities of network assets across pentests and dynamically adjust observability configurations. For example, the autonomous pentesting service may use cross-pentest insights 365 generated by the AI system 305 to assign risk priority levels to network assets (e.g., higher priority levels to network assets subject to attack in multiple pentests and/or lower priority levels to network assets appearing less frequently in autonomous pentests). The autonomous pentesting service may use the risk priority levels to adjust observability configurations, including increasing logging for higher priority network assets and decreasing logging for lower priority network assets.

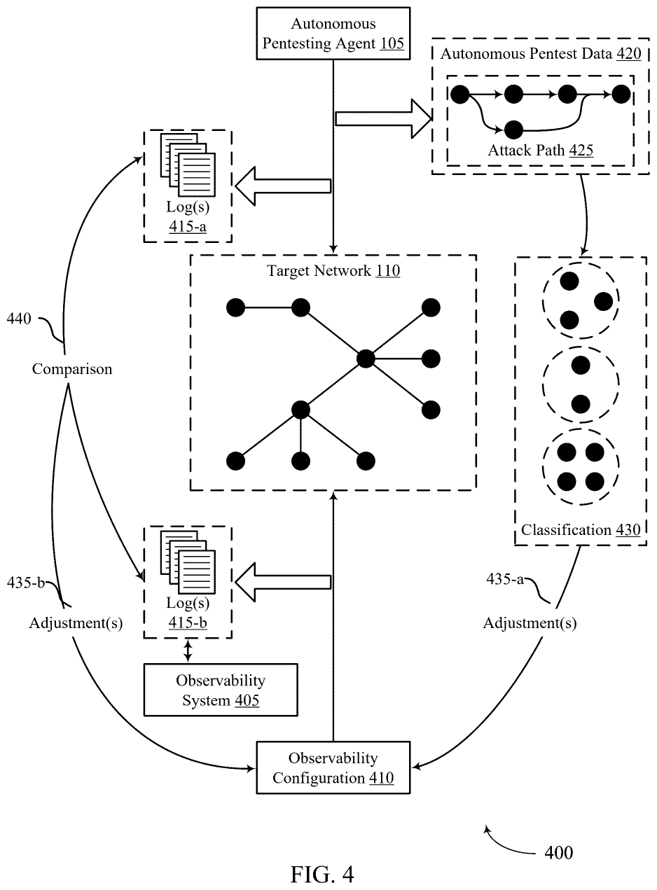

FIG. 4 shows an example of a flow diagram 400 that supports priority-based dynamic adjustment of observability configurations via autonomous pentesting in accordance with aspects of the present disclosure. The flow diagram 400 may implement or be implemented by the computing environment 100, the autonomous pentest map 200, the computing environment 300, or any combination thereof. For example, the flow diagram 400 may illustrate an autonomous pentest of a target network 110 by an autonomous pentesting agent 105.

In some examples, the target network 110 may record information about events within the target network 110 using an observability system 405 and according to an observability configuration 410. For example, network assets within the target network 110 may record their respective activity in accordance with the observability configuration 410 at the log(s) 415-b, which may be stored at the observability system 405 target network 110. The observability system 405 may be an example of a SIEM system (e.g., Splunk), an observability pipeline (e.g., Cribl), or another security tool (e.g., an Endpoint Detection and Response (EDR) system, an Extended Detection and Response (EDR) system, a Security Orchestration, Automation, and Response (SOAR) platform, etc.). For example, the observability system 405 may be an example of a system or component of a system that stores the log(s) 415-b associated with events on the target network 110 and/or performs attack detection based on the log(s) 415-b.

The autonomous pentesting agent 105 may execute one or more autonomous pentests of the target network 110 and obtain autonomous pentest data 420. During the one or more autonomous pentests of the target network 110, the autonomous pentesting agent 105 may perform autonomous pentesting operations along an attack path 425. According to the attack path 425, the autonomous pentesting agent 105 may perform a sequence of autonomous pentesting operations at a chain of network assets of the target network 110. For example, the autonomous pentesting agent 105 may perform a first operation that compromises a first network asset, use the first network asset to perform a second operation that compromises a second network asset, and so on. The attack path 425 may be an example of the attack path included in the autonomous pentest map 200 described with reference to FIG. 2. While a single attack path is illustrated with respect to FIG. 4, it should be understood that the autonomous pentesting agent 105 may perform autonomous pentesting operations along multiple attack paths during an autonomous pentest.

During the one or more autonomous pentests, the autonomous pentesting agent 105 may identify one or more exploitable attack paths (e.g., project attack paths, execute operations along attack paths, identify lateral movement possible from network assets, etc.). Additionally, or alternatively, the autonomous pentesting agent 105 may identify information associated with the target network 110, including network configurations, credential exposures, privilege escalation paths, misconfigurations, or the like. In other words, during one or more autonomous pentests, the autonomous pentesting agent 105 may gather autonomous pentest data 420, including information about the target network 110, possible or confirmed exploits of weaknesses and vulnerabilities in the target network 110, and information about network assets and relationships between network assets.

Based on the autonomous pentest data 420 gathered during the one or more autonomous pentests, the autonomous pentesting agent 105 may perform a classification 430. For example, the autonomous pentesting agent 105 may classify network assets compromised and/or identified during the one or more autonomous pentests into risk priority levels (e.g., high, medium, low, or informational priority). The autonomous pentesting agent 105 may classify the network assets into risk priority levels based on a context of each network asset within the network. For example, the context of a network asset may include permissions of the network asset, relationships between the network asset and other network assets in the target network 110, or a relative importance of the network asset compared to other network assets. For example, the context of a network asset may include a criticality level of the network asset indicative of a financial, operational, or reputational risk associated with the network asset (e.g., a “business” criticality of the network asset). In some examples, the criticality level may refer to a potential impact on confidentiality, integrity, and availability (the “CIA triad”) associated with a network asset. The context of each network asset may be identified via autonomous pentesting (e.g., the context may be included in the autonomous pentest data 420) and/or indicated via user input (e.g., by a user providing a network configuration, labeling criticality levels of assets, etc.).

Additionally, or alternatively, the autonomous pentesting agent 105 may classify the network assets into risk priority levels based on attack paths of the one or more autonomous pentests. For example, a risk priority level for a network asset may be based on one or more common vulnerability scoring system (CVSS) scores of one or more vulnerabilities of the network asset, one or more attack path lengths, and complexity of attack paths (e.g., a quantity of modules of each exploit in each attack path, a probability that the modules are successfully executed, etc.). Additionally, or alternatively, a risk priority level for a network asset may be based on historical autonomous pentest data, such as historical threat patterns, and/or predictions of possible attack paths.

The autonomous pentesting agent 105 may communicate with the observability system 405 to implement adjustments to the observability configuration 410 based on the classification 430. For example, the autonomous pentesting agent 105 may communicate with the observability system 405 via application programming interfaces (APIs), plugins, or via a component of the observability system 405 within the target network 110. The autonomous pentesting agent 105 may dynamically adjust logging, monitoring, and alerting settings based on the classification 430. That is, the autonomous pentesting agent 105 may perform adjustment(s) 435-a to settings in the observability configuration 410 based on the classification 430 of network assets into risk priority levels. The adjustment(s) 435-a may include increasing logging detail (e.g., enabling debug-level logs) for critical and high-priority assets; decreasing logging for low-priority assets (e.g., to reduce noise and re-allocate available storage to higher priority assets); and updating alert thresholds, sampling rates, and incident response workflows based on the classification 430.

In some examples, the autonomous pentesting agent 105 may support bidirectional feedback mechanisms to refine the classification 430. For example, the autonomous pentesting agent 105 may perform additional or follow-up adjustments to the observability configuration 410 based on re-classifying one or more assets in accordance with feedback from a user of the target network 110 and/or feedback from the observability system 405. That is, the observability system 405 may indicate information associated with collection of telemetry data, which the autonomous pentesting agent 105 may use to verify whether to perform additional or follow-up adjustments to the observability configuration 410 (or signals sent to the observability system 405). Additionally, or alternatively, the autonomous pentesting agent 105 may continuously update the classification 430 based on subsequent pentests of the target network 110. That is, after an autonomous pentest, the autonomous pentesting agent 105 may re-evaluate the classification 430 and perform subsequent adjustments to the observability configuration 410 based on changes to the classification 430.

In addition to or alternatively from performing the adjustment(s) 435-a based on the classification 430 of the network assets into risk priority levels, the autonomous pentesting agent 105 may perform adjustment(s) 435-b based on a comparison 440 of log(s) 415-a of the one or more autonomous pentests and the log(s) 415-b of the target network 110. That is, during the one or more autonomous pentests, the autonomous pentesting agent 105 may record each attacker command that is executed in the log(s) 415-a. The autonomous pentesting agent 105 may identify events missing from the log(s) 415-b of the target network 110 by comparing the log(s) 415-a of the autonomous pentests with events recorded in the log(s) 415-b of the network at times when the attacker commands were executed. For example, the autonomous pentesting agent 105 may identify that an event in the log(s) 415-a of the one or more autonomous pentests is absent from the log(s) 415-b via the comparison 440. In other words, the autonomous pentesting agent 105 may identify discrepancies between expected log entries and actual log entries and identify missing or misconfigured logs. The autonomous pentesting agent 105 may perform adjustment(s) 435-b to the observability configuration 410 based on the comparison 440. For example, the autonomous pentesting agent 105 may provide recommendations for updating logging policies. Examples of the adjustment(s) 435-b to the observability configuration 410 may include configuring webservers to maintain error logs, routers to send Virtual Teletype (VTY) line connection logs, Linux systems to send logs when a network card transmits above a threshold, Storage Area Network (SAN) devices to send Logical Unit Number (LUN) changes via Simple Network Management Protocol (SNMP) or system logs by default, or the like.

In some examples, the autonomous pentesting agent 105 may obtain the log(s) 415-b of the target network 110 via an API endpoint of the observability system 405. For example, the autonomous pentesting agent 105 may call the API endpoint of the observability system 405, which may retrieve data related to the target network 110 from a tenant of a customer associated with the target network 110. The data may include the log(s) 415-b, such as action logs for endpoints of the target network 110. The log(s) 415-b may include recorded commands and/or interactions in the target network 110 and may indicate which network assets were targeted by the autonomous pentests. For example, based on the log(s) 415-b, the autonomous pentesting agent 105 may validate whether the observability system 405 recorded events associated with the autonomous pentesting agent 105, and, if not, recommend the adjustment(s) 435-b.

In some examples, the observability configuration 410 may be set by users of the target network 110 (e.g., an Information Technology (IT) team of the target network 110) to confirm that the target network 110 is running properly and that operations are as expected. However, users of the target network 110 may be unaware of how the observability configuration 410 may be set and/or used to detect abnormalities in network activity indicative of attacks. Accordingly, the log(s) 415-b of the network may include general information and may not collect information by which attacks may be detected. In such examples, the autonomous pentesting agent 105 may implement the adjustment(s) 435-a and/or the adjustment(s) 435-b such that the observability configuration 410 may detect threat actors in the target network 110 while maintaining other uses of the observability system 405 by the target network 110 (e.g., still recording information that indicates whether the target network 110 is running properly, ensuring that the adjustments are safe, etc.).

The autonomous pentesting agent 105 may perform one or more subsequent autonomous pentests to validate the adjustment(s) 435-a and/or the adjustment(s) 435-b. For example, the autonomous pentesting agent 105 may compare logs of the one or more subsequent autonomous pentests to the log(s) 415-b of the target network 110 to determine whether, with the adjustments, the observability system 405 records events indicative of attacks to the target network 110.

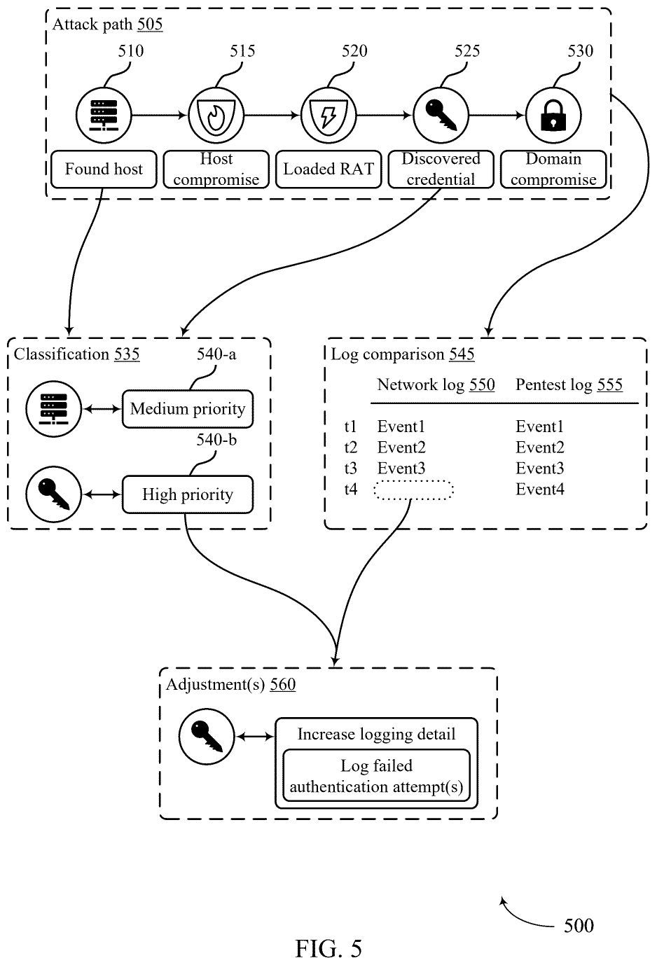

FIG. 5 shows an example of a flow diagram 500 that supports priority-based dynamic adjustment of observability configurations via autonomous pentesting in accordance with aspects of the present disclosure. The flow diagram 500 may implement or be implemented by the computing environment 100, the autonomous pentest map 200, the computing environment 300, the flow diagram 400, or any combination thereof. For example, the flow diagram 500 may illustrate an example of an attack path and corresponding logging configuration adjustment by an autonomous pentesting agent, such as the autonomous pentesting agent 105 described with reference to FIGS. 1 and 4.

An autonomous pentesting agent may, during an autonomous pentest of a network, perform a sequence of autonomous pentesting operations along an attack path 505. The attack path 505 may include a host 510, a host compromise 515, a RAT 520, a credential 525, and domain compromise 530.

The autonomous pentesting agent may perform classification 535 of network assets discovered via the attack path 505. For example, the autonomous pentesting agent may classify the host 510 as medium priority 540-a and the credential 525 as high priority 540-b. As an example, the autonomous pentesting agent may classify the credential 525 as having a higher priority level than the host 510 based on the domain compromise 530 immediately following discovery of the credential 525 (e.g., because domain compromise 530 is more severe than host compromise 515, which follows discovery of the host 510).

Additionally, the autonomous pentesting agent may perform a log comparison 545 of a network log 550 and a pentest log 555. For example, the autonomous pentesting agent may determine whether the network log 550 includes indication(s) of events that occurred during the autonomous pentest. In the example of FIG. 5, the network log 550 may be absent of Event4 which occurred in the pentest log 555. As an example, Event4 may indicate a failed authentication attempt using the credential 525.

The autonomous pentesting agent may perform adjustment(s) 560 based on the classification 535 and the log comparison 545. For example, the autonomous pentesting agent may increase the logging detail for the credential. Increasing the logging detail may include logging failed authentication attempt(s), such as based on the log comparison 545 indicating that the network log 550 did not include the failed authentication attempt using the credential 525.

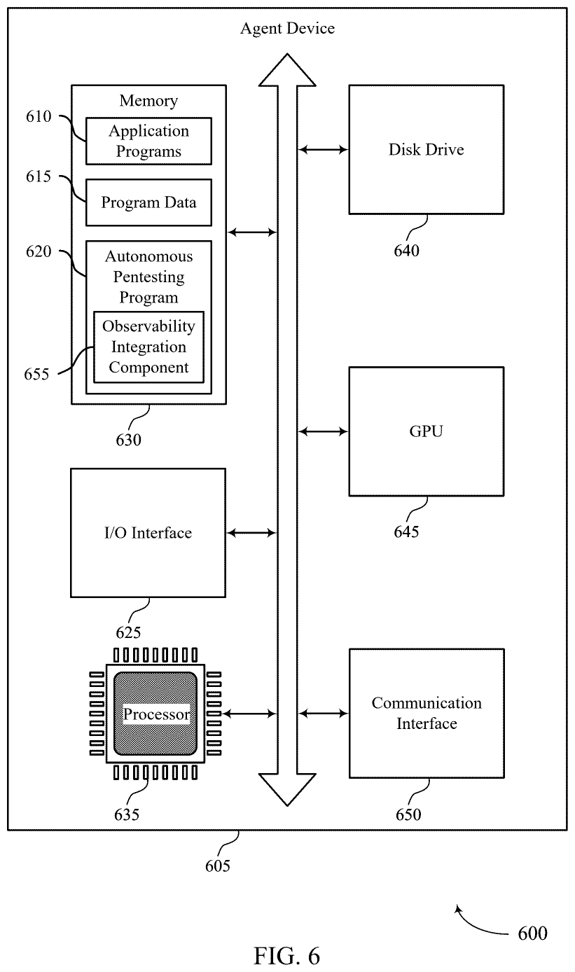

FIG. 6 shows a diagram of a system 600 including an agent device 605 that supports priority-based dynamic adjustment of observability configurations via autonomous pentesting in accordance with aspects of the present disclosure. The agent device 605 may be an example of a device or server on which an autonomous pentesting agent 105 is deployed as described herein. The agent device 605 may include components for priority-based dynamic adjustment of observability configurations via autonomous pentesting, such as a memory 630 including application programs 610, program data 615, an autonomous pentesting program 620, and a observability integration component 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting priority-based dynamic adjustment of observability configurations via autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting priority-based dynamic adjustment of observability configurations via autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving priority-based dynamic adjustment of observability configurations via autonomous pentesting.

The observability integration component 655 may support priority-based dynamic adjustment of observability configurations via autonomous pentesting in accordance with examples as disclosed herein. For example, the observability integration component 655 may be configured as or otherwise support a means for executing an autonomous pentest of a network, the autonomous pentest including performing one or more sequences of autonomous pentesting operations along one or more attack paths and at one or more network assets of a set of multiple network assets of the network. The observability integration component 655 may be configured as or otherwise support a means for classifying the one or more network assets into priority levels based on a context of each network asset of the one or more network assets within the network and on an attack path of the one or more attack paths of the autonomous pentest associated with each network asset. The observability integration component 655 may be configured as or otherwise support a means for performing one or more adjustments to an observability configuration in accordance with classifying the one or more network assets into the priority levels.

By including or configuring the observability integration component 655 in accordance with examples as described herein, the agent device 605 may support techniques for improved network security.

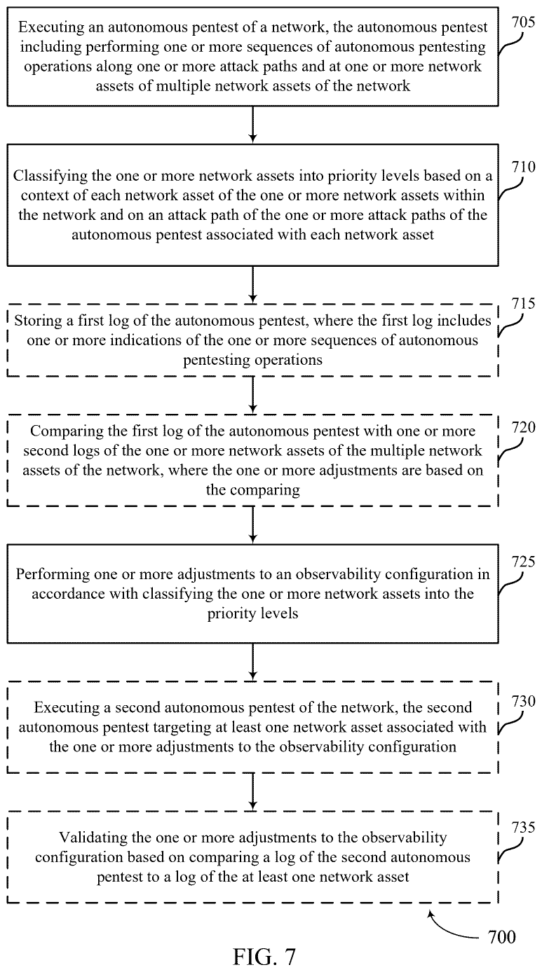

FIG. 7 shows a flowchart illustrating a method 700 that supports priority-based dynamic adjustment of observability configurations via autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include executing an autonomous pentest of a network, the autonomous pentest including performing one or more sequences of autonomous pentesting operations along one or more attack paths and at one or more network assets of multiple network assets of the network.

At 710, the method 700 may include classifying the one or more network assets into priority levels based on a context of each network asset of the one or more network assets within the network and on an attack path of the one or more attack paths of the autonomous pentest associated with each network asset.

At 715, the method 700 may include storing a first log of the autonomous pentest, where the first log includes one or more indications of the one or more sequences of autonomous pentesting operations.

At 720, the method 700 may include comparing the first log of the autonomous pentest with one or more second logs of the one or more network assets of the multiple network assets of the network, where the one or more adjustments are based on the comparing.

At 725, the method 700 may include performing one or more adjustments to an observability configuration in accordance with classifying the one or more network assets into the priority levels.

At 730, the method 700 may include executing a second autonomous pentest of the network, the second autonomous pentest targeting at least one network asset associated with the one or more adjustments to the observability configuration.

At 735, the method 700 may include validating the one or more adjustments to the observability configuration based on comparing a log of the second autonomous pentest to a log of the at least one network asset.

The following provides an overview of aspects of the present disclosure:

Aspect 1: A method for priority-based dynamic adjustment of observability configurations via autonomous pentesting, comprising: executing an autonomous pentest of a network, the autonomous pentest comprising performing one or more sequences of autonomous pentesting operations along one or more attack paths and at one or more network assets of a plurality of network assets of the network; classifying the one or more network assets into priority levels based at least in part on a context of each network asset of the one or more network assets within the network and on an attack path of the one or more attack paths of the autonomous pentest associated with each network asset; and performing one or more adjustments to an observability configuration in accordance with classifying the one or more network assets into the priority levels.

Aspect 2: The method of aspect 1, further comprising: storing a first log of the autonomous pentest, wherein the first log comprises one or more indications of the one or more sequences of autonomous pentesting operations; and comparing the first log of the autonomous pentest with one or more second logs of the one or more network assets of the plurality of network assets of the network, wherein the one or more adjustments are based at least in part on the comparing.

Aspect 3: The method of aspect 2, wherein the one or more adjustments comprise an increase in a logging frequency based at least in part on an absence in the one or more second logs of an indication of a first autonomous pentesting operation of the one or more sequences of autonomous pentesting operations.

Aspect 4: The method of any of aspects 2 through 3, further comprising: outputting a recommendation to perform the one or more adjustments based at least in part on comparing the first log with the one or more second logs, wherein performing the one or more adjustments is based at least in part on outputting the recommendation.

Aspect 5: The method of any of aspects 1 through 4, further comprising: executing a second autonomous pentest of the network, the second autonomous pentest targeting at least one network asset associated with the one or more adjustments to the observability configuration; and validating the one or more adjustments to the observability configuration based at least in part on comparing a log of the second autonomous pentest to a log of the at least one network asset.

Aspect 6: The method of any of aspects 1 through 5, further comprising: receiving, after performing the one or more adjustments, a feedback message from a user associated with the network indicating a requested parameter associated with the observability configuration; and performing one or more second adjustments to the observability configuration based at least in part on the feedback message, wherein the observability configuration is associated with the requested parameter after the one or more second adjustments.

Aspect 7: The method of any of aspects 1 through 6, wherein the one or more adjustments comprise: increasing a first logging frequency associated with a first network asset of the one or more network assets based at least in part on classifying the first network asset into a first priority level; and decreasing a second logging frequency associated with a second network asset of the one or more network assets based at least in part on classifying the second network asset into a second priority level, wherein the first priority level is associated with a higher priority than the second priority level.

Aspect 8: The method of any of aspects 1 through 7, wherein classifying the one or more network assets into the priority levels is based at least in part on a CVSS attack score, an attack path length, or both, associated with each attack path of the one or more attack paths.

Aspect 9: The method of any of aspects 1 through 8, wherein classifying the one or more network assets into the priority levels is based at least in part on a criticality level associated with each network asset of the one or more network assets, the criticality level indicative of one or more of: a financial risk associated with the respective network asset, an operational risk associated with the respective network asset, or a reputational risk associated with the respective network asset.

Aspect 10: The method of any of aspects 1 through 9, wherein classifying the one or more network assets into the priority levels is based at least in part on one or more stored autonomous pentesting operations performed prior to the autonomous pentest, the autonomous pentest, or both.

Aspect 11: The method of any of aspects 1 through 10, wherein classifying the one or more network assets into the priority levels is based at least in part on a difficulty level of one or more possible exploitations associated with each network asset of the one or more network assets, the difficulty level based at least in part on a quantity of modules associated with each possible exploitation of the one or more possible exploitations, a probability of successful execution of the quantity of modules associated with each possible exploitation, or both.

Aspect 12: The method of any of aspects 1 through 11, wherein the one or more adjustments comprise one or more logging frequencies, one or more alert thresholds, one or more sampling rates, one or more incident response workflows, or any combination thereof.

Aspect 13: An apparatus for priority-based dynamic adjustment of observability configurations via autonomous pentesting, comprising: one or more memories storing processor-executable code; and one or more processors coupled with the one or more memories and individually or collectively operable to execute the code to cause the apparatus to perform a method of any of aspects 1 through 12.

Aspect 14: A non-transitory computer-readable medium storing code for priority-based dynamic adjustment of observability configurations via autonomous pentesting, the code comprising instructions executable by one or more processors to perform a method of any of aspects 1 through 12.

Aspect 15: An apparatus for priority-based dynamic adjustment of observability configurations via autonomous pentesting, comprising at least one means for performing a method of any aspects 1 through 12.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for priority-based dynamic adjustment of observability configurations via autonomous pentesting, comprising:
executing an autonomous pentest of a network, the autonomous pentest comprising performing one or more sequences of autonomous pentesting operations along one or more attack paths and at one or more network assets of a plurality of network assets of the network;
classifying the one or more network assets into priority levels based at least in part on a context of each network asset of the one or more network assets within the network and on an attack path of the one or more attack paths of the autonomous pentest associated with each network asset; and
performing one or more adjustments to an observability configuration in accordance with classifying the one or more network assets into the priority levels.

2. The method of claim 1, further comprising:
storing a first log of the autonomous pentest, wherein the first log comprises one or more indications of the one or more sequences of autonomous pentesting operations; and
comparing the first log of the autonomous pentest with one or more second logs of the one or more network assets of the plurality of network assets of the network, wherein the one or more adjustments are based at least in part on the comparing.

3. The method of claim 2, wherein the one or more adjustments comprise an increase in a logging frequency based at least in part on an absence in the one or more second logs of an indication of a first autonomous pentesting operation of the one or more sequences of autonomous pentesting operations.

4. The method of claim 2, further comprising:
outputting a recommendation to perform the one or more adjustments based at least in part on comparing the first log with the one or more second logs, wherein performing the one or more adjustments is based at least in part on outputting the recommendation.

5. The method of claim 1, further comprising:
executing a second autonomous pentest of the network, the second autonomous pentest targeting at least one network asset associated with the one or more adjustments to the observability configuration; and
validating the one or more adjustments to the observability configuration based at least in part on comparing a log of the second autonomous pentest to a log of the at least one network asset.

6. The method of claim 1, further comprising:
receiving, after performing the one or more adjustments, a feedback message from a user associated with the network indicating a requested parameter associated with the observability configuration; and
performing one or more second adjustments to the observability configuration based at least in part on the feedback message, wherein the observability configuration is associated with the requested parameter after the one or more second adjustments.

7. The method of claim 1, wherein the one or more adjustments comprise:
increasing a first logging frequency associated with a first network asset of the one or more network assets based at least in part on classifying the first network asset into a first priority level; and
decreasing a second logging frequency associated with a second network asset of the one or more network assets based at least in part on classifying the second network asset into a second priority level, wherein the first priority level is associated with a higher priority than the second priority level.

8. The method of claim 1, wherein classifying the one or more network assets into the priority levels is based at least in part on a common vulnerability scoring system (CVSS) attack score, an attack path length, or both, associated with each attack path of the one or more attack paths.

9. The method of claim 1, wherein classifying the one or more network assets into the priority levels is based at least in part on a criticality level associated with each network asset of the one or more network assets, the criticality level indicative of one or more of: a financial risk associated with the respective network asset, an operational risk associated with the respective network asset, or a reputational risk associated with the respective network asset.

10. The method of claim 1, wherein classifying the one or more network assets into the priority levels is based at least in part on one or more stored autonomous pentesting operations performed prior to the autonomous pentest, the autonomous pentest, or both.

11. The method of claim 1, wherein classifying the one or more network assets into the priority levels is based at least in part on a difficulty level of one or more possible exploitations associated with each network asset of the one or more network assets, the difficulty level based at least in part on a quantity of modules associated with each possible exploitation of the one or more possible exploitations, a probability of successful execution of the quantity of modules associated with each possible exploitation, or both.

12. The method of claim 1, wherein the one or more adjustments comprise one or more logging frequencies, one or more alert thresholds, one or more sampling rates, one or more incident response workflows, or any combination thereof.

13. An apparatus for priority-based dynamic adjustment of observability configurations via autonomous pentesting, comprising:
one or more memories storing processor-executable code; and
one or more processors coupled with the one or more memories and individually or collectively operable to execute the code to cause the apparatus to:
execute an autonomous pentest of a network, the autonomous pentest comprising performing one or more sequences of autonomous pentesting operations along one or more attack paths and at one or more network assets of a plurality of network assets of the network;
classify the one or more network assets into priority levels based at least in part on a context of each network asset of the one or more network assets within the network and on an attack path of the one or more attack paths of the autonomous pentest associated with each network asset; and
perform one or more adjustments to an observability configuration in accordance with classifying the one or more network assets into the priority levels.

14. The apparatus of claim 13, wherein the one or more processors are individually or collectively further operable to execute the code to cause the apparatus to:
store a first log of the autonomous pentest, wherein the first log comprises one or more indications of the one or more sequences of autonomous pentesting operations; and
compare the first log of the autonomous pentest with one or more second logs of the one or more network assets of the plurality of network assets of the network, wherein the one or more adjustments are based at least in part on the comparing.

15. The apparatus of claim 14, wherein the one or more adjustments comprise an increase in a logging frequency based at least in part on an absence in the one or more second logs of an indication of a first autonomous pentesting operation of the one or more sequences of autonomous pentesting operations.

16. The apparatus of claim 14, further comprising:
outputting a recommendation to perform the one or more adjustments based at least in part on comparing the first log with the one or more second logs, wherein performing the one or more adjustments is based at least in part on outputting the recommendation.

17. The apparatus of claim 13, wherein the one or more processors are individually or collectively further operable to execute the code to cause the apparatus to:
execute a second autonomous pentest of the network, the second autonomous pentest targeting at least one network asset associated with the one or more adjustments to the observability configuration; and
validate the one or more adjustments to the observability configuration based at least in part on comparing a log of the second autonomous pentest to a log of the at least one network asset.

18. A non-transitory computer-readable medium storing code for priority-based dynamic adjustment of observability configurations via autonomous pentesting, the code comprising instructions executable by one or more processors to:
execute an autonomous pentest of a network, the autonomous pentest comprising performing one or more sequences of autonomous pentesting operations along one or more attack paths and at one or more network assets of a plurality of network assets of the network;
classify the one or more network assets into priority levels based at least in part on a context of each network asset of the one or more network assets within the network and on an attack path of the one or more attack paths of the autonomous pentest associated with each network asset; and
perform one or more adjustments to an observability configuration in accordance with classifying the one or more network assets into the priority levels.

19. The non-transitory computer-readable medium of claim 18, wherein the instructions are further executable by the one or more processors to:
store a first log of the autonomous pentest, wherein the first log comprises one or more indications of the one or more sequences of autonomous pentesting operations; and
compare the first log of the autonomous pentest with one or more second logs of the one or more network assets of the plurality of network assets of the network, wherein the one or more adjustments are based at least in part on the comparing.

20. The non-transitory computer-readable medium of claim 19, wherein the one or more adjustments comprise an increase in a logging frequency based at least in part on an absence in the one or more second logs of an indication of a first autonomous pentesting operation of the one or more sequences of autonomous pentesting operations.
